(19) United States
(12) Patent Application Publication
(10) Pub. No.: US 2004/0220884 A1
(43) Pub. Date: Nov. 4, 2004

(54) Intelligent internet bargaining system

(76) Inventor: Saadat H. Khan, Chatham, NJ (US)

Correspondence Address: Ernest D. Buff, Ernest D. Buff & Associates, LLC, 245 South Street, Morristown, NJ, 07960, US

(21) Appl. No.: 10/286,306

(22) Filed: Nov. 1, 2002

(51) Int. Cl. G06F 17/60

(52) U.S. Cl. 705/80

(57) ABSTRACT

An electronic intelligent bargaining system enables buyers to bargain with the system in order to negotiate an optimum bargain price; and enables sellers to sell or list their products by bargaining with the system to negotiate the best-offered price. The system permits purchase and sale of goods to be transacted at a bargained for price that represents the best bargain obtained by the parties. A bargained for price for transactions consummated by the electronic bargaining system is reached by the parties in a highly reliable manner using an electronic assistant, called “BargainGuru” or “BAGU”. Principal attributes of that bargained for price are those captured by the characterization: “Our Best Bargain, Your Best Bargain”.

### BACKGROUND OF THE INVENTION

1. Field of the Invention

The present invention relates to electronic commerce applications that utilize digital and analog networks; and, more particularly, to a method and system for conducting electronic commerce over the Internet.

2. Description of the Prior Art

Computerized marketplaces are enjoying widespread use. These marketplaces have been successfully run domestically and in many foreign countries. Computerized markets range from simple classified ad, bulletin boards to complex mainframe-based market systems, such as NASDAQ, which provides a real-time market-making system for tens of thousands of securities brokers. Modern stock, bond and commodity exchanges are supported by computerized databases and related background systems that enable them to function.

Typically, electronic Exchanges are designed to facilitate commercial transactions involving tokens of ownership, such as shares of stock or physical objects such as cars, gold and the like. Other Exchanges specialize in the sale of information stored on databases that require payment of access fees to content providers for proscribed content downloaded by the user. Still other Exchanges provide matching services for parties seeking an efficient way to find each other. An example of matching services provided by an Exchange of this kind are the services afforded by a dating service or a job bank.

Exchanges can also function to support a market place for the buying and selling of consulting services. These types of Exchanges support a form of activity that is appointed to take place in the future. The Exchange serves as a structured meeting ground for the negotiation of the service to be provided. During operation of these types of systems, both parties must disclose their identities to each other. When trading is imminent, one party simply contacts the other directly and privately, without the Exchange's knowledge, thereby avoiding any costs, which might otherwise have been assessed by the Exchange.

Working expert exchange marketplaces, whether they are physical or electronic, require a complete and highly specialized set of conditions in order to function and thrive. Certain ingredients or features of service, if missing, can result in a shortage of either buyer or seller or lead to the collapse of the Exchange. Sufficient qualification of each is clearly needed for continued operation. At the same time, the Exchange must be able to ensure that income derived from the commerce of its activities is sufficient to cover operating costs and sustain profitability.

Exchanges should also provide sufficient motivation to ensure that significant numbers of buyers and sellers use the exchange in lieu of other available market place alternatives. Several factors, if present, would motivate buyers and sellers to use an exchange: (i) there must exist a high expectation of the usefulness of the Exchange that makes the user willing to take the time and effort to learn the rules of the exchange; (ii) buyers and sellers should be able to locate each other on the exchange at exactly the right time and place; (iii) a buyer and a seller should be able to quickly and easily negotiate transaction terms; (iv) buyers and sellers must reach a complete and final agreement in which the expectations of the parities are well defined; (v) there must exist an arrangement for acceptable credit terms; (vi) a mechanism should be provided for delivery of the goods or services called for by the agreement; (vii) there must exist a mechanism to deliver payment when the agreement is fulfilled; (viii) buyers and sellers must be able to rely on the Exchange to enforce agreements made on the Exchange with certainty of payment and legal recourse; transaction fees must be reasonable in comparison to alternatives; buyers and sellers should enjoy ready access to the market without levels of knowledge and cost of hardware commensurate with the value of the goods or services sold on the Exchange.

Traditional real world commerce in expertise or consulting services strongly favors circumstances where both parties are in the same place at the same time and can see one another. When there is no face-to-face contact and the parties instead rely on mail, phone, faxes etc., significant burdens and costs are imposed. These burdens and costs reduce the likelihood that expert commerce will take place. This is especially true if the parties are located in countries with different languages, customs, legal systems, currencies etc. Each added burden dramatically reduces the chances for agreement and makes it more difficult to satisfy all of the previously noted infrastructure conditions. If one or both of the parties in an online transaction is a private-party with no established organization or commercial resources, the difficulties heretofore discussed tend to increase.

Notwithstanding the problems faced in this field, the twenty-first century demand for worldwide commerce and Exchange services is expected to increase dramatically. A myriad of businessmen, government officials, academics and ordinary consumers now interact with each other via online networks. Consequently, the demand for worldwide commerce and Exchange services is growing dramatically.

To exploit this potential growth, there is needed a universally accessible facilitating system. Such a system should be especially designed to process the purchase and sale of goods and services in an effective, smartly structured manner. It must be thorough and cover aspects of an arms-length bargain not present when goods and services are electronically purchased or sold in the conventional way.

Computerized stock markets seamlessly and effortlessly process transactions of billions of shares of equities, bonds and financial instruments every day. In like manner, there exists a need for a mechanism that facilitates purchase and sale of goods at an optimum price. Especially needed is a system wherein the buyer and seller need not see or meet each other; but can deal effectively through use of a structured, organized system that facilitates and supports the infrastructure needed for commercial transactions involving purchase and sale of goods. Also, the buyers and sellers may not be available at the same time to negotiate a deal, but a system is needed for effective Internet based electronic commerce.

### SUMMARY OF THE INVENTION

A system for electronic bargaining using the Internet is described in detail in my copending patent application Ser. No. 09/864,043. The present invention provides an intelligent electronic bargaining system that helps users in selecting various options available within the system using the electronic assistant BargainGure, also called “BAGU”. The BAGU collects user preferences including the buyer's product selection and purchase preferences as well as sellers pricing strategy for negotiating a final price. BAGU can negotiate on behalf of the seller or buyer in the absence of either present on an on-line terminal and is empowered to conduct negotiations and come up with a negotiated selling price. This bargaining system: (i) enables buyers to bargain with the system in order to negotiate an optimum bargain price; and (ii) enables sellers to sell or list their products by bargaining with the system using selling rules, during which process the system responds to buyer's offers to negotiate the best offered price. Advantageously, the system permits purchase and sale of goods to be transacted at a bargained for price that represents the best bargain obtained by the parties. That is to say, a bargained for price for transactions consummated by the electronic bargaining system is reached by the parties in a highly reliable manner. Principal attributes of that bargained for price are those captured by the characterization: “Our Best Bargain, Your Best Bargain”.

The present invention provides a structure for the BAGU intelligent Internet bargaining assistant, and a plurality of methods for accomplishing the desired negotiated outcomes. For the sake of clarity, different elements of the system, which are previously described in copending patent application Ser. No. 09/864,043 are repeated herein.

Generally stated, the Intelligent Internet Bargaining system includes: 1) a Business Controller unit adapted to process buyer requests and to initiate a bargain process structured to provide an optimum price for each of the buyer and the system. The Business Controller unit is further adapted to process seller requests and bargaining guidelines and to initiate a bargain process structured to provide an optimum price offered to the seller by the system. It is connected with a database unit that searches the database to generate a search result, and processes the search results according to the buyer and seller request and requirements. The Business Controller is connected to the bargain module which uses the data stored in various databases and facilitates the bargaining process either on-line or off-line with buyer and or seller. It also interacts with the memory resident program ‘BargainGuru” if installed and subscribed by the buyer or the seller during the bargaining process as well as a desktop navigator. The Business Controller is connected to i) a database controller unit having all required databases such as payment database, billing database, buyer database, seller database, and product database; ii) an Expert device for using the database information to create BargainGuru; and iii) a transceiver disposed in communication with the Business Controller unit, for transmitting Business Controller generated responses to buyers and the sellers and receiving buyer and seller requests to initiate a bargain process.

### BRIEF DESCRIPTION OF DRAWINGS

The invention will be more fully understood and further advantages will become apparent when reference is had to the following detailed description and the accompanying drawings, in which:

FIG. 1 is a block diagram illustrating the functional components of the present Internet bargaining system, including Business Controller 2.0, algorithmic and or artificial intelligence expert unit 1.8, database controller 3.0, buyer interface 5.0, and vendor or seller interface 6.0;

FIG. 2 is a block diagram illustrating the functional components of Business Controller 2.0;

FIG. 3 is a block diagram illustrating the functional components of database controller 3.0;

FIG. 4 is a block diagram illustrating the functional components distributed over an Internet network 1.1;

FIG. 5 is a block diagram illustrating the functional components of the buyer interface 5.0;

FIG. 6 is a block diagram illustrating the functional components of the seller interface 6.0;

FIG. 7 is a flowchart illustrating off-line bargaining with a buyer;

FIGS. 8a and 8b depict a flowchart illustrating off-line bargaining with a seller;

FIG. 9 is a flowchart illustrating on-line bargaining with a buyer;

FIG. 10 is a flowchart illustrating on-line bargaining with a seller;

FIG. 11 is a flowchart illustrating a bargain price generation process by Business Controller 2.0 during bargain negotiations with buyer;

FIG. 12 is a flowchart illustrating a method wherein the seller registers himself with the Business Controller 2.0;

FIGS. 13a and 13b depict a block diagram illustrating BargainGuru (“BAGU”) desktop functionality; and

FIG. 14 is a block diagram illustrating usage of BargainGuru BAGU.

### DESCRIPTION OF THE PREFERRED EMBODIMENTS

The term “bargaining” as used herein means a process used by two or more parties to arrive at an agreement, which governs certain rights and duties between them. In particular, this bargaining process may occur with or without the sellers being present on a terminal with the Intelligent bargaining system representing the interests of the sellers finding the most optimum deal for the buyer using the pricing guidelines and bargaining strategies of the sellers. During the bargaining process, the negotiating parties give reasoning and incentives to convince the other party to come to terms. This whole process is referred to herein as bargaining. The end result is an agreement on which the parties execute accordingly. The bargaining process is accomplished using an intelligent business controller which can negotiate with the buyer responding to his offerings without having the need of the physical presence of the sellers, using the negotiation parameters set by the sellers.

Advantageously, the Internet bargaining system of the present invention affords new features and value-added services to the customers that have not heretofore been available. It fulfills a longstanding need for a buyer-driven bargaining system that enables the buyer to bargain for the price he wants with a multitude of sellers, each having their own price negotiation strategies. In addition, the system provides a buyer-driven bargaining system that avoids sellers concerns about publicity and price of their product. That is to say, the system provides a unique Internet bargaining structure that proceeds on the basis of “our bargain price, your bargain price”.

In general, the Internet bargaining system provides the following services and features for the buyers and sellers.

The buyer is able to find bargains at a price most suitable to him. In use of the Internet bargaining system described above, it is unnecessary for the buyer or seller to see or meet each other or be connected to IBS at the same time. The system provides substantially all information about the product, and questions concerning the product are addressed. Buyers can contact the system at a convenient time using a variety of communication modes. Preferably a buyer uses a communication mode selected from the group consisting of on-line, off-line and real-time. Each of these communication modes will be described hereinafter in further detail. At the request of the Buyer, the system can provide assistance via prompts, pop-up messages instant messages, chat applets and icons, thereby enabling Buyer to proceed with the bargaining process on his own. Assistance from a system consultant is also provided, upon Buyer request.

Sellers obtain a negotiated and best available price for their products. Substantially all bargains are negotiated by the buyers to obtain an optimum price for seller goods or services. The sellers declare their pricing and negotiating strategies, for example, the range of prices from high to low and steps of decrements to be offered to the buyer during negotiation which may be linear in its simplest form or may follow a complicated pricing strategy. For example, the seller's price offer may depend on how fast the price offered to the buyer is decreasing from his starting point to provide the next step of offer price. The buyer may have specific requirements including model preferences, manufacture and marketing regiments of the products including a specific product or service provider as well as shipping preferences. In one embodiment, the system processes all the financial matters of the deal for the buyer and the seller. Sellers do not have to engage in the troublesome task of bargaining with single or multiple buyers one at a time if they so choose since the system handles this bargaining process. The system operates as an optimized and expert middleman between the buyer and the seller. Transactions can be negotiated and consummated on a real time basis or off line, on the basis of bargained for, mutually agreeable terms.

These features, in combination, provide an Internet bargaining system that is easy to use and enables bargaining to be carried out and bargains reached in an effective, cost efficient manner.

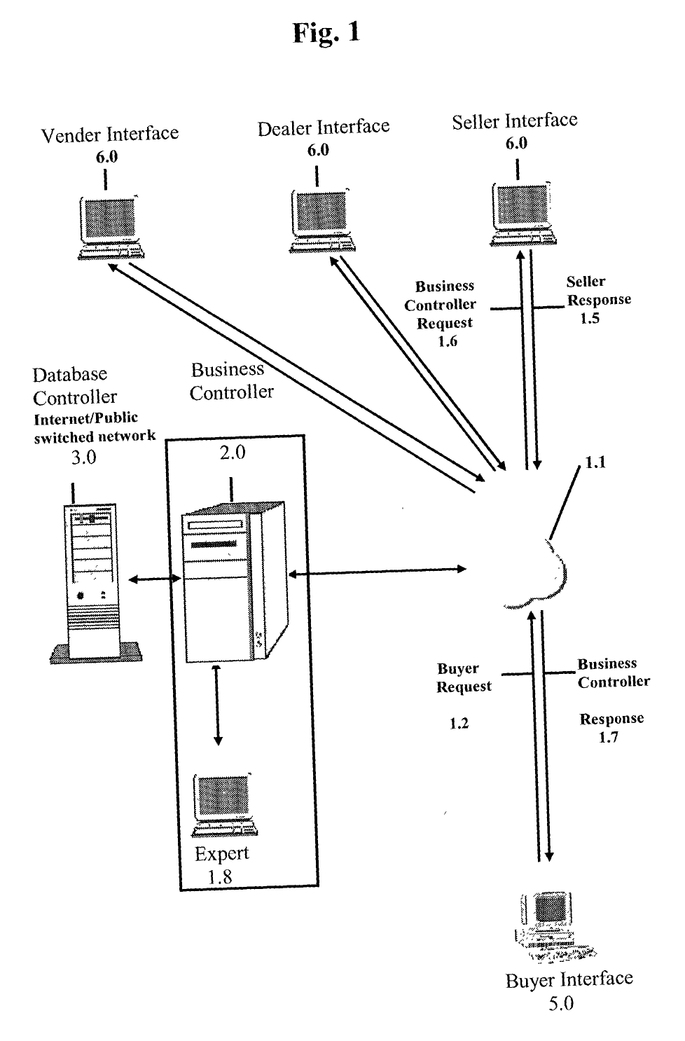

Referring to FIGS. 1-6 of the drawings, there is shown the method and apparatus of the present invention. In a preferred structure the system of the invention comprises: a buyer interface 5.0, database controller 3.0, business controller 2.0 with expert system 1.8 an intelligent algorithm based on preferences of sellers and buyers and an associated database. The system identifies the appropriate mode of bargain, supervises the bargain requests by the user, and processes those requests to produce appropriate bargain responses. Advantageously, in operation of the system, the buyer and seller, whether they are present or not in an active terminal can arrive at a suitable bargain price in a simple cost and time effective manner. The term “user” is herein intended to mean a buyer or seller that accesses the system to participate in a bargaining process, bench mark a product or service, or otherwise obtain information concerning products or services offered by the system or a system franchise or licensee.

The system architecture for the preferred structure of the present Internet bargaining system is illustrated in FIGS. 1, 2, 3, 5, and 6. Referring again to FIG. 1, the apparatus comprises Business Controller 2.0 with expert system 1.8, an algorithmic and artificial intelligence directly connected to it and a database controller 3.0 which is connected through the Internet via a public switched network or VPN (Virtual Private Network) i.e. car dealership or a mall auction scenario. Other Internet connections include a buyer interface 5.0, a seller interface 6.0, (collectively, called the “nodes”). Each node is connected via an Internet connection using a public switched phone network 1.1, such as those provided by a local or regional telephone operating company. Connection can also be provided by dedicated Data lines, cellular phones, “Personal communication system (PCS)”, computer or device and/or hand-held devices, and microwave or satellite networks. Buyer interface 5.0 and seller interface 6.0 are used both as inputs and as output gateways for communications with Business Controller 2.0.

The method and apparatus of the invention utilizes these components to implement a unique bargaining system in which buyers and sellers, who are not present at a bargaining terminal, can interact with a Business Controller 2.0 assigned expert to arrive at a price that optimally suits their demands. The assigned expert 1.8 can comprise a system-generated assistant, referred to herein as a “BargainGuru”. It can also comprise a consultant, available on an on-line or off-line basis, to provide assistance or otherwise facilitate the bargaining process.

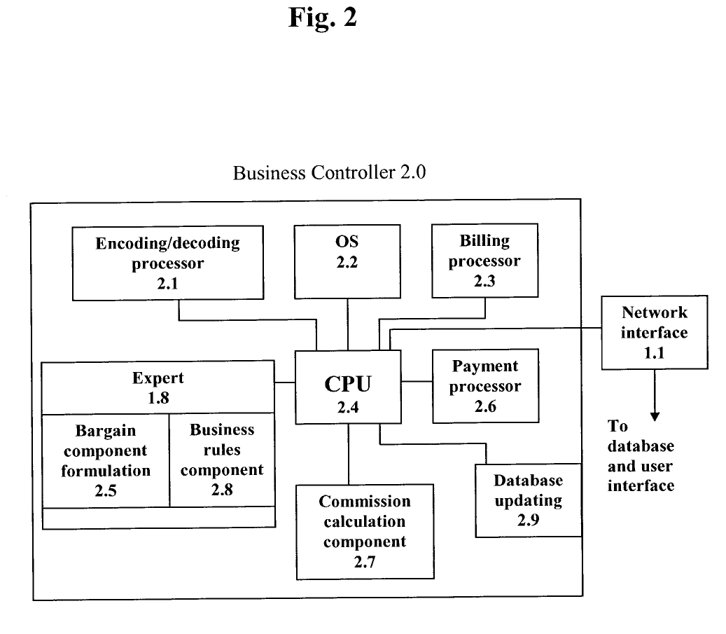

As illustrated by FIG. 2 of the drawings, Business Controller 2.0 includes central processor (CPU) 2.4, encoding/decoding process 2.1, payment processor 2.6, Bargain formulation processor 2.5, part of the expert system, Commission formulation processor 2.7, Business rules component 2.8, part of the expert system, Operating system 2.2, and network interface 1.1. Connections to the databases for billing and payment processing and database updating functions are accomplished over the Internet as indicated in FIG. 1. The Business Controller 2.0 uses this information to coordinate a bargaining process with the help of the expert system 1.8. A conventional personal computer or workstation with sufficient memory and processing capability may be used as Business Controller 2.0. Alternatively, the Business Controller 2.0 can be a mainframe and may comprise a hand held communication device such as a Palm Pilot®, WordPad® or the like.

In one embodiment, Business Controller 2.0 operates as a Web server, both receiving and transmitting data inquiries generated by buyers and sellers. Business Controller 2.0 must be capable of processing high volume transaction, performing a significant number of mathematical calculations in processing communications. A Pentium-II 300 MHz microprocessor or better commonly manufactured by Intel Inc. may be used for CPU 2.4. This processor employs a 32-bit architecture. Other processors suitable for use as CPU 2.4 include Motorola 120 MHZ PowerPC or Sun Microsystems SOLARIS.

People who like to see the product and/or service before they purchase will be able to bargain for it using some or all of the features of our Business Controller 2.0 using the expert system. As for example, a web-site called PriceBargains.com will set-up bargaining terminals/stations/booths etc. in stores, warehouses, dealerships or any public place suitable for bargaining etc. or franchise the bargain terminals/stations/booths etc. or license the software to the vendors or sign-up vendors in regional bargain site whereby the customer(s) can go and bargain for the products and/or services and avoid the sales persons pressure or interaction in purchasing the product(s) and or service(s). Bargain terminals/stations/booths will have a linkage to a mainframe system, which is connected to distributed PriceBargains.com systems. The seller of the product(s) and/or service(s) will link the product(s) and/or service(s) to their mainframe system for further linkage to distributed ‘PriceBargains.com’ system to keep a track of the product(s) and/or service(s). The PriceBargains.com system will display several features including but not limited to the control number, description/photograph, price etc. for the customer(s) to be able to see and bargain for the products and or services using vendors in close proximity to the customer or out of state vendors who may ship the product by mail or other appropriate means. All products listed regionally or otherwise will have a product i.d./tracking number on the web site as well as on each item displayed in the store. This will help track the product inventory in a better fashion for managing the stores i.e. if the product is bought by someone else in the store, or by a customer using the bargaining terminals/stations/booths. The PriceBargains.com main system will be updated automatically and will no longer show the product on the screen for other customers if the store stock has been exhausted. This function can be successfully performed in a franchise scenario using Internet or Intranet network connections.

Once the product(s) and/or service(s) information is entered into the bargaining system i.e. scan code product i.d. or tracking number, photograph, product description etc., the customer(s), before they start bargaining through either of the sites, will be able to see, test drive etc. the product(s) and/or service(s) offering they are purchasing or wish to purchase. If for example a customer is buying a car, he can go to the dealership, select the car he wants to buy, test drive it etc., and then without being pressured by the sales person, go to the bargaining terminal/station/booth, sign in as a member, (if he is not a member, enter his information to become a member) as the bargaining terminals/booths/stations will be linked to the main system of PriceBargains.com or simply log on to PriceBargains.com website. Once logged-on, the customer(s) can start bargaining for the product(s) and/or service(s) either with a live person(s) sitting in the back office or through the automated parameters set behind the scene.

Once the price has been agreed upon either at the vendor's site or PriceBargains.com site. The system will allow the buyer to print bargain acceptance coupon or bargain acceptance receipt. or get an acceptance number along with the product i.d. or tracking number which will evidence that the buyer has entered into a legally binding contract or the buyer would have the option of paying at the site terminal whereby the system will then issue a bargain acceptance purchase receipt and allow the buyer to either present that bargain acceptance coupon or bargain acceptance receipt etc. to the vendor to get the discount and purchase the product. Alternatively, the customer can submit the bargain acceptance coupon or bargain acceptance certificate or receipt number to PriceBargains.com to purchase the product and to process the order and ship the product to the buyer.

In another scenario, the bargain terminals/stations/booths may be set up without linking the products and/or services to PriceBargains.com main frame: The seller of the product(s) and/or service(s) will either franchise or pay a monthly fee or the usage fee for setting up bargain terminals/stations/booths at the vendors location and will link the store inventory to the franchised bargaining system bargain terminals/stations/booths to keep a track of the product(s) and/or service(s) which will display several details including but not limited to the control number, scan code description/photograph, price etc., using products and services available within a limited location. The customer(s) will be able to see and bargain for products and/or services in the vendor's location through the bargaining terminals/stations/booths. All products listed or displayed on the bargain terminal will have a product i.d./tracking number and/or scan code on the web site as well as on each item displayed in the store. This will help track the inventory in a better fashion. If the product is bought by someone else in the store, the bargaining terminals/stations/booths will get updated automatically and no longer show the product on the screen. In either scenario, the seller will have either a live person(s) sitting in his back office of the vendor back office bargaining with the customer(s) or the seller or the bargain terminals will have automated pricing parameters to allow for bargaining as described previously in the application.

Once the product(s) and/or service(s) information is either entered or scanned into the bargaining system i.e. product i.d. or tracking number, photograph, product description or the like, the customer(s), before they start bargaining through either of the sites, will be able to see, test drive etc. the product(s) and/or service(s) they are purchasing or wish to purchase. If for example a customer is buying a car, he can go to the dealership, select the car he wants to buy, test drive it etc., and then without being pressured by the sales person, go to the bargaining terminal/station/booth located at the vendor location, either sign-on if he is already a member or sign-on to become a member or without becoming a member, enter the product i.d. or perform a search to locate the product and start bargaining as described previously herein.

Once the price has been agreed upon at the vendor's site, the system will allow the buyer to either print a bargain acceptance coupon or a bargain acceptance receipt/certificate etc., or get an acceptance number along with the product i.d. or tracking number evidencing that the buyer has entered into a legally binding contract or allow the buyer to pay at the terminal and issue a bargain acceptance purchase receipt with the terms and conditions and take the product with him/her without going to a cashier. If the buyer decides to pay to the cashier, the buyer then can take that bargain acceptance certificate coupon/receipt, etc. to the cashier or sales person/clerk to get the discount and purchase the product within the local region.

PriceBargains.com revenue is generated by (i) franchising the business module; or (ii) licensing the business module/software; or (iii) charging a monthly fee; (iv) charging according to the usage of the system; or (v) agreement with the vendor/seller covering payment from seller to PriceBargains.com based on usage of the system or sale of vendor's product.

Customers could potentially bargain with at least two different vendors that supply the same or similar product as per buyer's request. In such a case, each vendor or the customer depending on the system configuration will have a number of chances or time limit to go back and forth by way of bargaining, either on-line or off-line. In the customer controlled scenario, whichever vendor gives the lowest price or offer the best deal will get the business. In the vendor controlled scenario once the time limit/# of tries are over, the buyer has to decide if he/she would like to proceed with the purchasing process. This scenario is applicable to business to business or business to customer environment.

Alternatively, if a buyer sees a product offered on a website by his or her preferred vender which has a higher quote in the comparative quote analysis, the buyer has the option of bargaining with his or her preferred vendor. In such an instance, the buyer asks the system to approach the preferred vendor to either match, reduce the price by a certain percentage or amount, provided that the product offered by the other vendor has substantially the same features. Buyer provides the system with details concerning the other vendor's product for transmission to the preferred vender. In addition, the buyer guarantees that buyer will purchase the product, if the price is agreed upon or accepted by the vendor. For example, a buyer wants to purchase an airline ticket non-stop from JFK Airport, NY to O'Hare Airport, Chicago, and requests the system for comparative quote analysis. In the comparative quote analysis the system shows fares from airline A, B, C, D, and E. Airline E has the lowest fare, but the buyer prefers airline A because of frequent flyer miles or for some other reason. In this scenario, the buyer will be able to bargain through the system with airline A and request the airline to either match, reduce or discount the fair by a certain percentage or amount. When making this request, buyer must also guarantee that buyer will purchase the ticket if the airline accepts his request. Alternatively, if the buyer has already purchased a product, he can ask another vendor to beat the price that the buyer has already paid by giving details or showing proof of purchase to the vendor about the product and guaranteeing that if the vendor beats the price, the buyer will purchase the product unconditionally from that vendor.

Each of billing processor 2.3 and payment processor 2.6 can comprise a conventional microprocessor (such as Intel Pentium) supporting the transfer and exchange of payments, charges, or debits attending transactions processed. These processors may also be configured as part of CPU 2.4.

Processing of credit card transactions may be supported with commercially available software, such as the Secure Web server manufactured by Open Market Inc. This server software transmits credit card numbers electronically to the Open Market headquarters for card-processing verification. An Integrated Commerce Service at the Open Market headquarters provides back-office services necessary to run Web-based businesses. The back-office services include online account statements, order-taking and credit card payment authorization, credit card settlement, automated sales tax calculations, digital receipt generation, and account based purchase tracking and payment aggregation for low priced services.

The bargain formulation processor 2.5 and the commission calculation processor 2.7 can comprise conventional microprocessors (such as Intel Pentium) that support mathematical processing of different bargain prices and calculation of commissions. A business rules component 2.8 can use this type of microprocessor for its functionality.

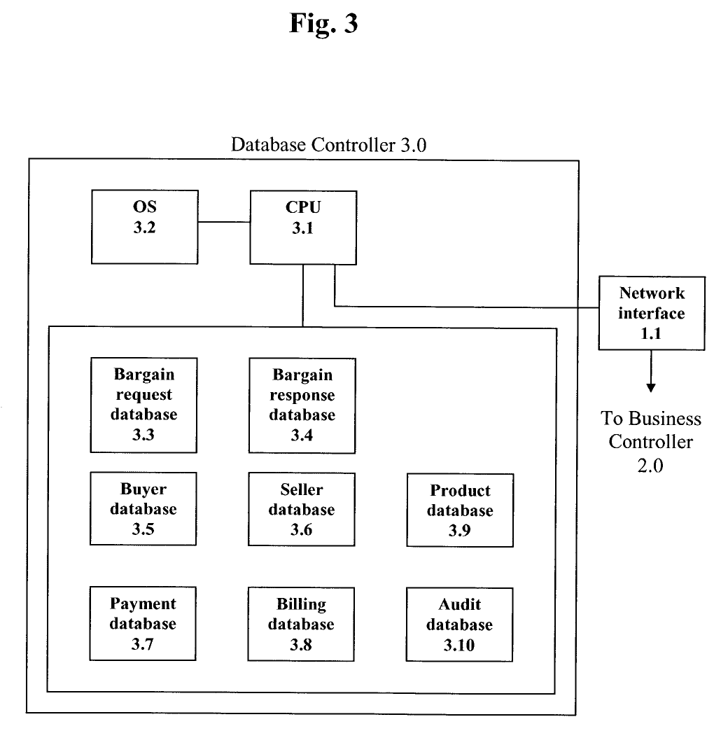

A database controller 3.0, shown in FIG. 3, comprises a computer system having sufficient memory and processing capability. In one embodiment, database controller 3.0 operates as a Database Server, both receiving and transmitting data inquiries generated by the Business Controller 2.0. The data may include product I.D., control number, inventory status, functionality description of the product, photograph of the product, vendor location, pricing and bargaining strategies of the vendor including but not limited to starting price, price decrements during bargaining for offering prices, schemes for decrementing the price during bargaining and the like.

Fulfilling the high volume transaction processing and data queries required during operation of the Internet bargaining system requires a powerful microprocessor. A Pentium II 300 MHz microprocessor commonly manufactured by Intel Inc. can comprise CPU 3.1. Other equivalent microprocessors may also be used.

A data storage device of the type suitable for use with the invention generally includes magnetic storage devices such as fixed discs, and the like. These storage devices will be used for housing the databases used in the processing of transactions by the system. These databases include buyer database 3.5, seller database 3.6, product database 3.9, bargain request database 3.3, bargain response database 3.4, payment database 3.7, billing database 3.8, and audit database 3.10. In a preferred embodiment database software such as Oracle 8, manufactured by Oracle Corporation, is used to create and manage these databases. The network interface is shown at 1.1.

Buyer database 3.5 maintains data on each buyer, including name, address, phone, E-mail, payment preference, language preference, product preference, currency preference and the like. It may also include buyer preferences including but not limited to the location of the vendor, product features including out of date products, Grey market products, shipping means, insurance and location of service facility and service provisions and the like. Seller database 3.6 maintains data on each seller such as name, address, phone, E-mail, language preference, past selling record, product ID, price range preference for sale of the product either as a single item or in bulk, or as a package deal, availability of the product, condition of the product, picture, if available, and the like. In addition, seller database 3.6 contains information about the product ID, and any advertising data of the product to be sold. The seller database 3.6 also holds information about bargain bids and the response and acceptance generation by the system.

The Bargain request database 3.3 includes all buyer requests 1.2 received by Business Controller 2.0, indexed by product ID. A unique tracking number is also stored for each buyer request 1.2.

The bargain response database 3.4 contains all bargain responses issued by Business Controller 2.0. This database is indexed by the request tracking number. Bargain response database 3.4 also contains all the bargain prices issued by the Business Controller 2.0 in the bargaining process of a product.

Payment database 3.7 and billing database 3.8 track all commercial transactions, as well as payment and billing preferences and, optionally, shipping details and product tracking information. These databases are valuable in the event of inquiries by both buyer and seller so that an audit trail can be produced in the database 3.10. Product database 3.9 maintains product ID and other details about the product as well as any acceptable restrictions/duties/stamp or VAT taxes etc.

Audit database 3.10 stores transactional information that may be retrieved for later analysis; for example, the buyers and sellers negotiations proceedings from chat rooms, or audit trails by the Business Controller 2.0 might be stored in this database so that buyer or seller inquiries concerning service or price, or the transaction history can be independently verified.

Network interface 1.1 provides a gateway for communication with buyers and sellers through a buyer interface and a seller interface, respectively. Conventional internal or external modems serve to provide the network interface. The modem is supported at a baud rate ranging from 28800 upwards, but may combine such inputs into a t1 or t3 line, if more bandwidth is required.

In a preferred embodiment, network interface 1.1 is connected with the Internet and/or any of the commercial Internet service providers, such as AOL, CompuServe, IBM, and the like. This allows both buyers and sellers to access the system from a wide range of online connections. As used herein, the term “connection” means a conventional wired connection as would be provided by a modem and telephone line or, alternatively, a connection, such as that provided by a wireless modem, cell phone or the like. Several commercial e-mail servers may also be included in the above functionality, for example when PriceBargains.com is contacted to obtain prices instead of using the BargainGuru.

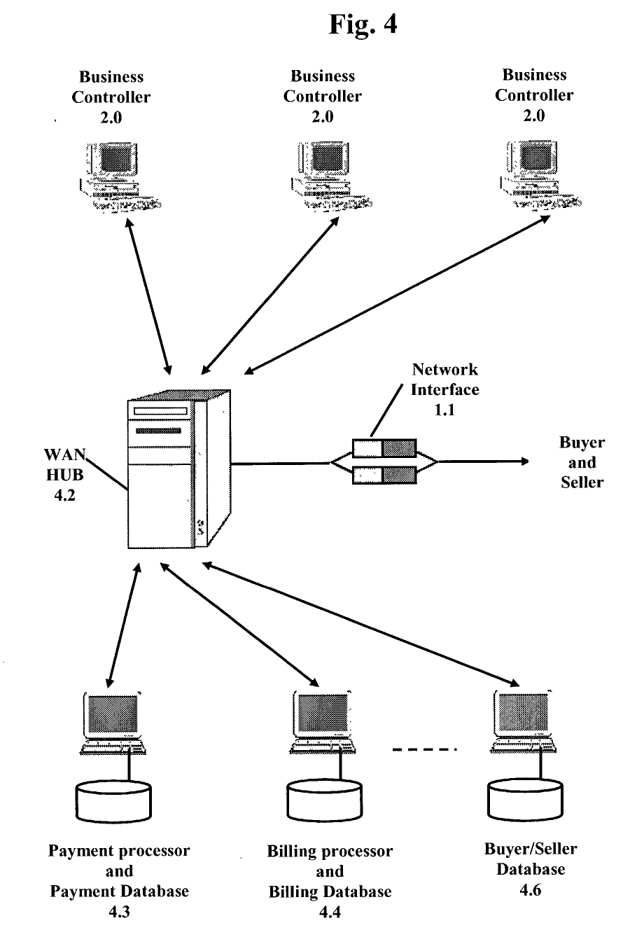

Although the foregoing embodiment describes a single computer acting as the Business Controller, it will be readily appreciated by those skilled in the art that the functionality can be distributed over a plurality of computers. In another embodiment the Business Controller 2.0 and the database controller 3.0 are configured in a distributed architecture, shown by FIG. 4, wherein the database and processor components are housed in separate units or locations. Business Controller 2.0 with intelligent expert systems 1.8 components perform the primary processing functions and contain at a minimum RAM, ROM and a general processor. Each of these controllers is attached to WAN HUB 4.2 that serves as the primary communication link with the other devices WAN hub 4.2 may have minimal processing capability itself, serving primarily as a communications router.

Although a limited number of controllers are shown in this embodiment those skilled in the art will appreciate that an almost unlimited number of controllers may be supported. In such configuration, each controller is in communication with its constituent port, but stand-alone units perform the processor and/or data storage functions.

Payment processor and database 4.3, billing processor and database 4.4, and buyer/seller database 4.6 communicate through WAN Hub 4.2 with controllers 4.7 through 4.9. With this arrangement, the system is more flexible and dynamic, and less vulnerable to catastrophic hardware failures.

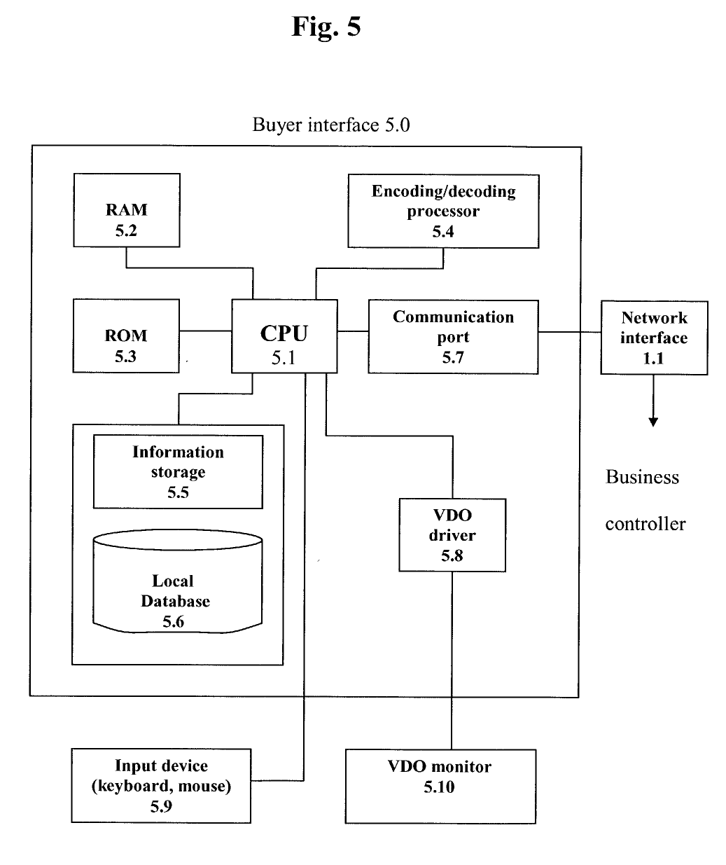

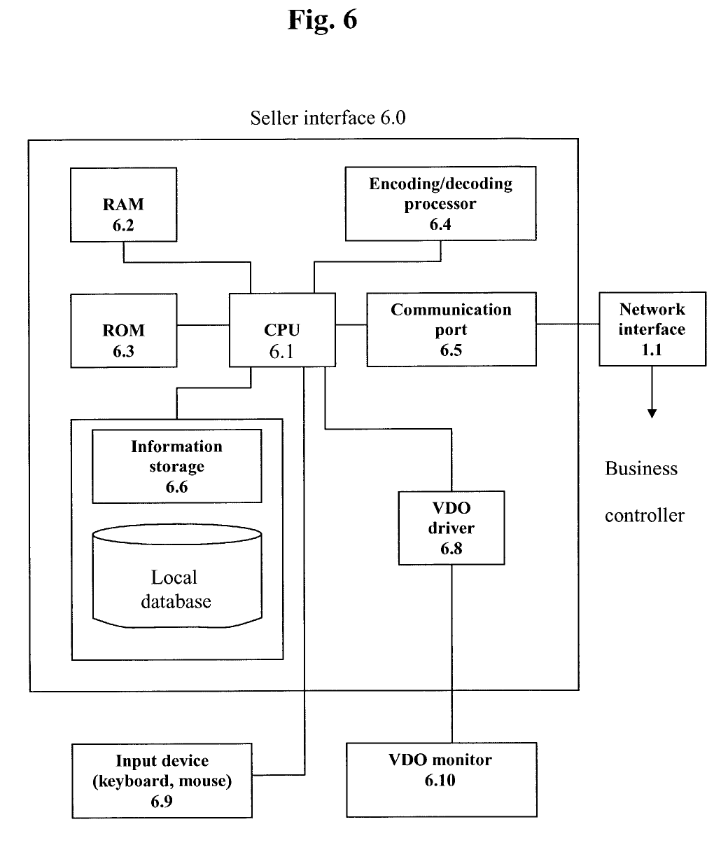

In FIGS. 5 and 6 there is illustrated a buyer interface and a seller interface, respectively. Typically, each of these interfaces is provided by a personal computer having an input device such as keyboard, mouse, or conventional voice recognition software package. Each of the buyer and seller interfaces also has a display device such as a video monitor, a processing device such as a CPU, and a network interface such as a combination of modem and an ISP connection. Alternatively, the buyer interface 5.0 and seller interface 6.0 may also be voice mail system, or other electronic or voice communication system. Devices such as fax machines or pagers are also suitable interfaces. Buyer and seller interfaces other than on-line via the Internet will be managed through the phone system and the bargaining process will be facilitated by customer service agents.

Referring to FIG. 5, there is shown a buyer interface that includes central processor (CPU) 5.1, RAM 5.2, ROM 5.3, video driver 5.8, video monitor 5.10, communications port 5.7, input device 5.9, network interface 1.1 and a data storage device. Each of these components is substantially identical to those shown in FIG. 6.

The primary functions of the seller interface 6.0 and the buyer interface 5.0 are message creation and transmission using commercial messaging tools in the form of applet. Numerous commercial software applications can enable the communications required by seller interface 6.0 and buyer interface 5.0. MS Outlook Express, manufactured by Microsoft, for example, provides editing tools for the creation of messages as well as communication tools to route the message to the appropriate electronic address.

Referring to FIG. 6 there is shown seller interface 6.0. The seller interface includes central processor (CPU) 6.1, RAM 6.2, ROM 6.3, video driver 6.8, video monitor 6.10, communication port 6.5, input device 6.9, network interface 1.1, and data storage device 6.6. CPU 6.1 can be comprised of a Pentium microprocessor such as 100 MHz P54C. CPU 6.1 has a standard chip-based clock, which is used to timestamp the seller request produced with seller interface 6.0. A modem is required to transmit data to Business Controller 2.0 for further processing so that the seller's product may be advertised open for bargain and given a starting bargain price. The encoding and decoding processor 6.4 is required to encode and decode data transferred to and from Business Controller 2.0. Data and decoding processor will be discussed at a later stage. Data storage device 6.6 is a conventional magnetic based hard disk storage unit, such as those manufactured by Western Digital. Information database 6.6 is used for archiving seller requests and the bargain details, payment records and shipping details are recorded at local database 6.7.

Asynchronous Bargaining Embodiment

In one embodiment of the current invention, the communication between buyers and the sellers takes place asynchronously through Business Controller 2.0. The buyer creates buyer request 1.2, transmits it to the Business Controller 2.0 and then disconnects from the network. The Business Controller 2.0 generates a buyer response 1.3, accepting the request. In the event that the buyer request is not acceptable, the Business Controller 2.0 generates a new bargain price for the buyer and sends it to the buyer for consideration. The buyer then generates a new buyer request based on the new bargain price received from Business Controller 2.0. This process is continued until (i) an acceptable price is arrived at, or (ii) one of the parties to the transaction discontinues the bargaining process, or (iii) the product or service becomes unavailable, or (iv) buyer runs out of chances or does not request additional chances, or (v) the predetermined time period allotted for bargaining has expired.

Alternatively in the case of seller, the seller sends a seller request containing a seller's offered price and details about his product to the Business Controller 2.0 and disconnects from the network. Business Controller 2.0 then generates a response having the form of (i) disapproval of seller's request or (ii) request for more details, or (iii) acceptance of the seller request, or (iv) provisional acceptance of seller request based on a modified bargain price or modified product or service offering suggested by the Business Controller 2.0. In the event that the seller request is not accepted by the Business Controller 2.0, the seller generates a seller request based on the response received from Business Controller 2.0. This process is continued until (i) an acceptable seller request is arrived at, or (ii) one of the parties to the transaction discontinues the bargaining process, or (iii) the seller decides to list the product on open sale, as described herein, or (iv) the seller runs out of chances or declines to purchase additional bargaining chances, or (v) the predetermined time for bargaining has expired. In either case the buyer or seller does not communicate with the Business Controller in real time. Alternatively, the BargainGuru of the expert system 1.8 can generate a seller response using the pricing guidelines set by the seller.

The BargainGuru system can also offer an automated bargaining feature (proxy buying/selling) without either party knowing the other one is on-line or off-line. The BargainGuru system will bargain on behalf of the buyer or the seller if they so choose and bargain on their behalf with the price range identified by them. The BargainGuru will get the best possible deal for the buyer or the seller. The BargainGuru system can also bargain for the product and/or service on behalf of the buyer, whereby the system can or a live person can go to at least two different vendors that supply the same or similar product, and allow each vendor to bargain either with each other, or with the system or with a live person, either on-line or off-line to offer the best price for the product to the buyer. In the end whoever bids the lowest price or offers the best deal will get the buyers business.

Offline Communications with Buyer

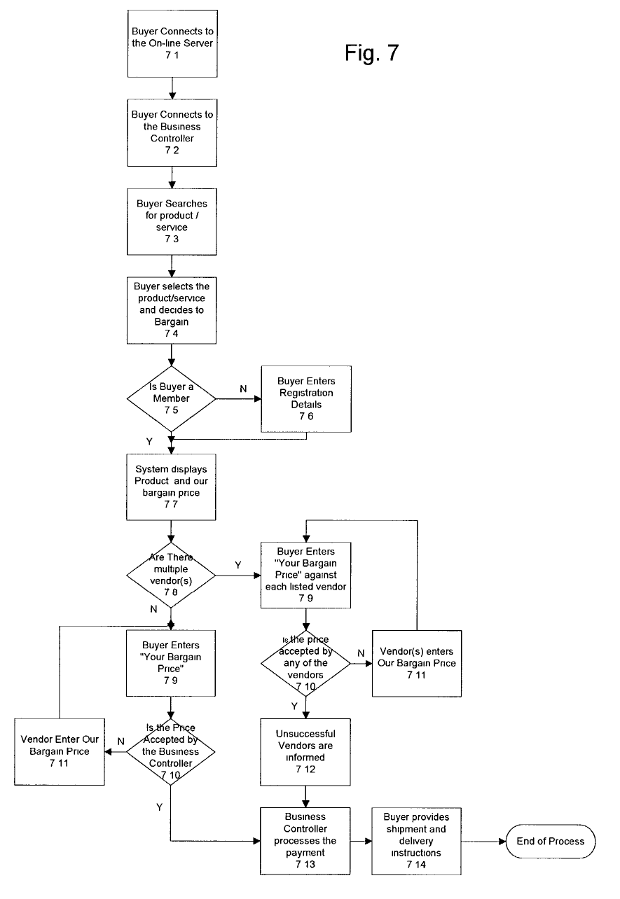

With reference to FIG. 7, there is described the process by which buyer goes to a bargain terminal/station/booth in a public place and formulates buyer request 1.2.

The buyer first creates a request at step 7.1, by choosing a product and/or service from the given list of (i) products, which include airline tickets, new and used cars, electronic components, computer peripherals, groceries, furniture, antiques, and the like; and/or (ii) services, which include legal services, consulting services, babysitting services, maid services, medical services, and the like. It will be appreciated by those skilled in the art that the list of products and services includes a myriad of products and services, that is to say, virtually any product or service which is required by a consumer or business entity and can be readily valued and priced for sale, and which is susceptible for purchase and sale in a bargaining context. The term “product”, as used herein is intended to include any product(s) and/or service(s) that constitutes subject matter adapted to be priced and sold for a bargained for consideration.

The buyer either attaches his ID number or membership number to the request or registers on site and obtains a membership or ID number at step 7.2, or proceeds without registering at step 7.3.

At step 7.4, the buyer transmits his bargain price to the on site Business Controller 2.0, which controls and updates the inventory of the products and/or services by way of a product ID or tracking number. Business Controller 2.0 at step 7.5 stores buyers request, and checks to see if the bargain price requested by the buyer meets the criteria for acceptance. If at step 7.6, the buyers bargain price is accepted, Business Controller 2.0, at step 7.7 either processes the payment or issues a bargain acceptance certificate/coupon/receipt along with a product ID or tracking number and the location of the product. If the Business Controller 2.0 at step 7.7 does not accept the bargain price offered by the buyer, it continues the bargaining process through different iterations as defined herein at step 7.8.

The bargaining terminals will be equipped with the appropriate text messaging tools for generating/exchanging on-line offers and counter offers for the desired product/service. As long as the message conforms to standards established by the Business Controller 2.0, an email program is capable of generating and transmitting buyer request.

The standard would specify the message address, the information to be contained in the subject heading, and the processing order of the body of the message. The first line of the body of the message, for e.g. may contain the ID of the buyer. The second line is the product, third line the model and the fourth line the price buyer is willing to pay. In an off-line scenario the buyer may request for product or service and use standard forms could also be electronically mailed to the buyer, allowing him to simply fill in the blanks and return buyer request 1.2 to Business Controller 2.0. Similar forms and standards could be applied to fax and postal mail transmission.

Offline Communications with Seller

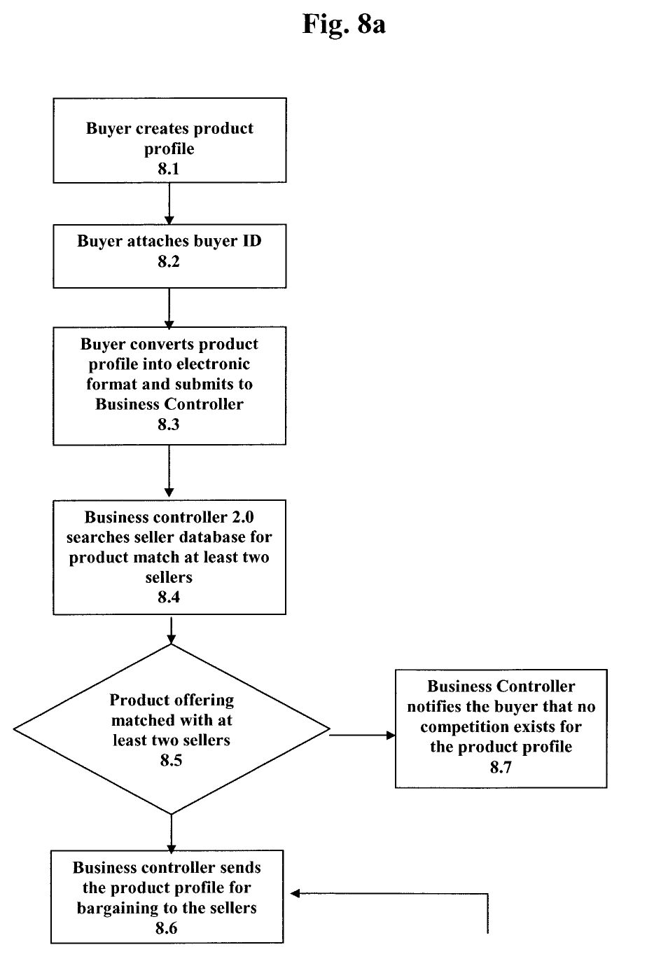

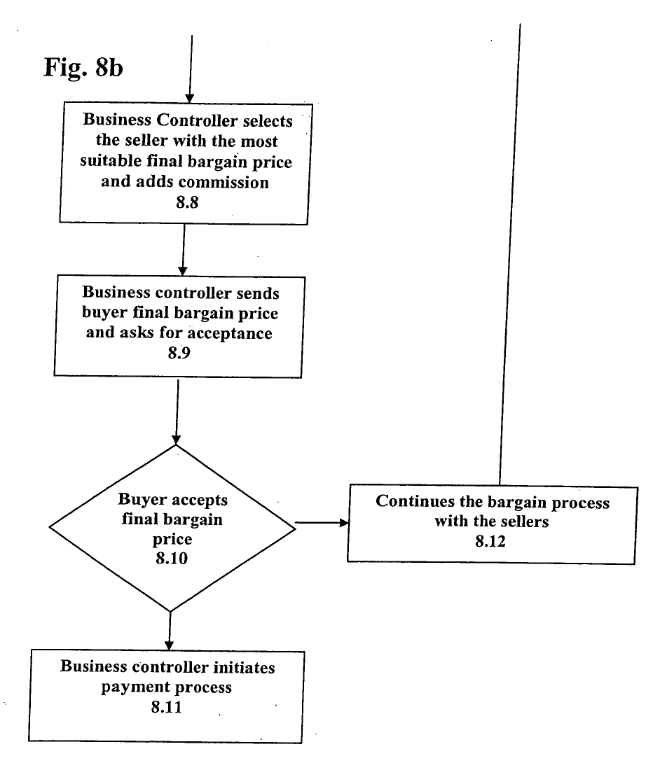

Referring to FIGS. 8a and 8b there is illustrates an embodiment in which the bargaining process is conducted in a proxy buying scenario. The business controller informs the buyer if the required product/service is found in the database along with the price quotation from the vendors of the products and services. If the initial price for the product/services offered by at least one of the vendor is acceptable to the buyer the business controller informs the buyer and proceed with the acceptance and the payment process. Alternatively, the Business Controller provides the buyer with a list of vendors offering the same or similar products and their initial quote. The buyer has to select one of the vendors and give control to the BargainGuru system to act on his behalf for the bargaining process. At step 8.1 the buyer creates a product profile giving specific details about the product, for example, category, type, make, model, color, and the like. At step 8.2, the buyer attaches his ID or membership number with the product profile. Thereafter, at step 8.3, the buyer converts the product profile into an electronic format and transmits his request to Business Controller 2.0. Transmission of the request at step 8.3 can, alternatively, be accomplished by facsimile, electronic mail or regular mail. Business Controller 2.0 captures the buyer request and the offered price, at step 8.4 searches in seller database 1.4 to match at least two sellers meeting the buyer's product profile. If the product profile submitted by the buyer matches the sellers product offerings, then at step 8.5, Business Controller 2.0 sends the buyers profile to the sellers meeting the product offering, and allows them to bargain with each other to arrive at the lowest or a most suitable final bargain price for the buyer at step 8.6. If at step 8.7, Business Controller 2.0 cannot find at least two sellers, it informs the buyer that no competition exists, and stops the search. In the event at step 8.8 Business Controller 2.0 selects the lowest or the most suitable final bargain price, and add a predetermined percentage typically at least about 1%, preferably about 5% to 20%, and more preferably about 10% to 15% based on the final bargain or sale price of the product or service, and updates response database 3.4. At step 8.9, Business Controller 2.0 sends the sellers final bargain price to the buyer, and asks for acceptance. If at step 8.10 buyer accepts the final bargain price offered by the Business Controller 2.0, then at step 8.11, Business Controller 2.0 initiates the payment process, arranges for the shipment of the product, and pays the seller as per the agreed upon terms and conditions. In the event buyer does not accept the final bargain price, then at step 8.12, Business Controller 2.0 continues to bargain process with the seller as per the iterations described herein.

Online Bargaining with Buyer

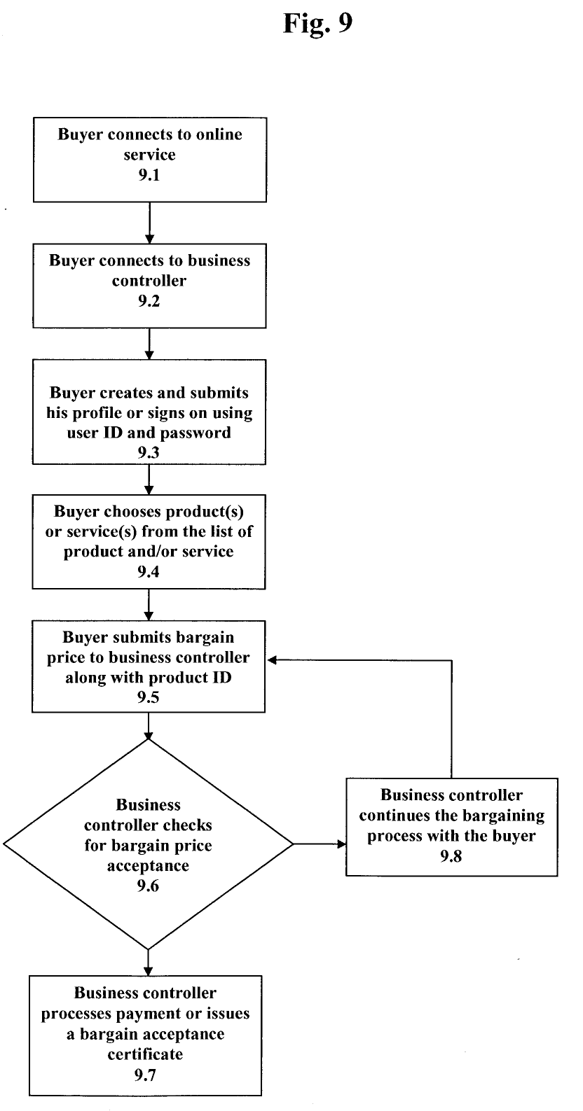

FIG. 9, there is described the process by which buyer can first see the product, then go to either an on site bargaining terminal/station/booth in a public place such as shopping mall/car dealer/airport/Internet café/retail store and the like or connects to Business Controller 2.0 from the location of his convenience and formulates buyer request 1.2.

At step 9.1 buyer connects to an online server. At step 9.2 buyer connects to Business Controller 2.0. At step 9.3 buyer creates his profile to register or if buyer is already a member, uses his user ID and password and submits it to Business Controller 2.0 as defined herein. Here buyer provides buyer's name, address, phone number, e-mail address, city, state, country, preferred language and the like, At step 9.4 buyer chooses a product and/or service from the given list of (i) products, which include airline tickets, new and used cars, electronic components, computer peripherals, groceries, furniture, antiques, and the like; and/or (ii) services, which include legal services, consulting services, babysitting services, maid services, medical services, and the like. It will be appreciated by those skilled in the art that the list of products and services includes a myriad of products and services, that is to say, virtually any product or service which is required by a consumer or business entity and can be readily valued and priced for sale, and which is susceptible for purchase and sale in a bargaining context. The term “product”, as used herein is intended to include any product(s) and/or service(s) that constitutes subject matter adapted to be priced and sold for a bargained for consideration.

At step 9.5, the buyer transmits his/her bargain price to Business Controller 2.0, which interacts with all the components of the Intelligent Bargaining System and controls and updates the inventory on a real time basis of the products and/or services by way of a product ID or tracking number. Business Controller 2.0 at step 9.6 stores buyers request, and checks to see if the bargain price requested by the buyer meets the criteria for acceptance. If at step 9.7, the buyers bargain price is accepted, Business Controller 2.0 either processes the payment or issues a bargain acceptance certificate/coupon/receipt along with a product ID or tracking number and the location of the product. If the Business Controller 2.0 at step 9.8 does not accept the bargain price offered by the buyer, it continues the bargaining process through different iterations as defined herein.

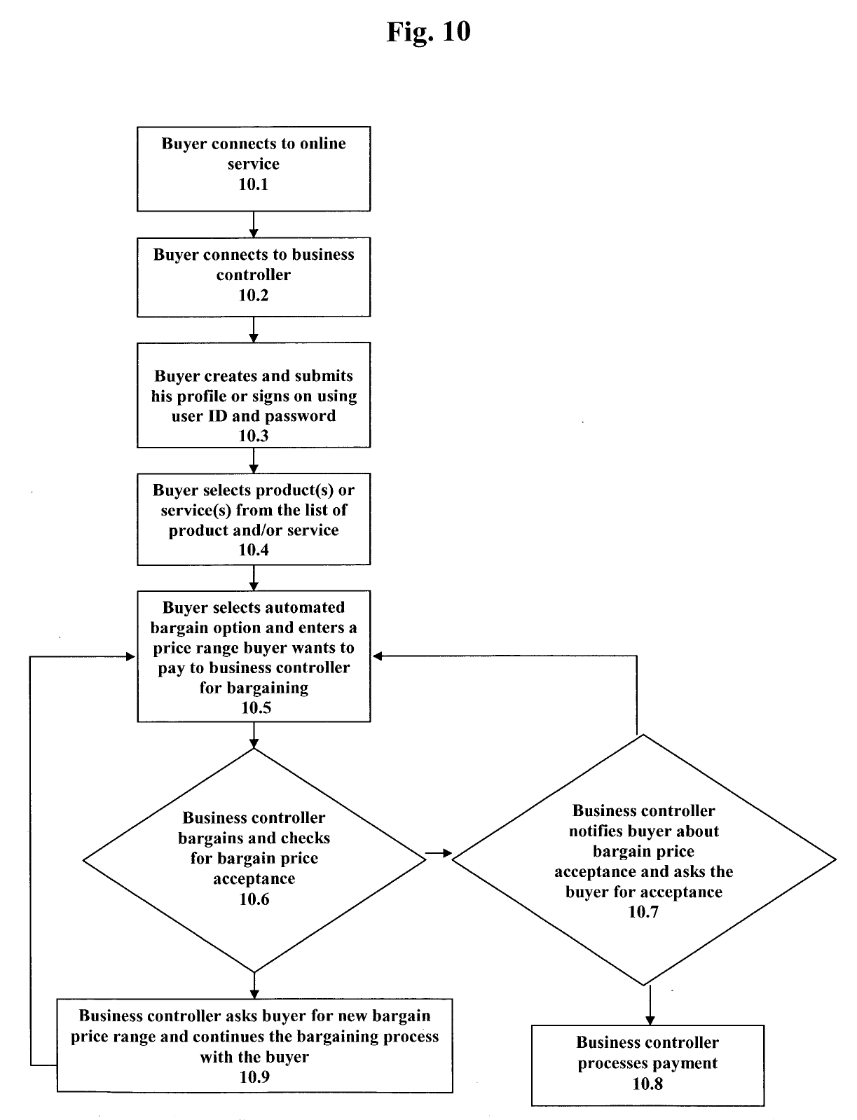

FIG. 10, there is illustrated a method by which buyer creates a profile and registers with the system online or if the buyer is already a registered member, uses buyers user ID and password to connect online to Business Controller 2.0. Buyer connects to an online service provider as defined herein at step 10.1. At step 10.2 buyer connects to Business Controller 2.0. At step 10.3 buyer creates and submits the profile or signs on using his user ID and password as defined herein. At step 10.4 buyer selects the product(s) and/or service. At step 10.5 buyer selects an automatic bargaining option by entering a price range the buyer wants to pay and submits to Business Controller 2.0 for bargaining. At step 10.6, if the Business Controller 2.0 after bargaining automatically through different iterations as defined herein accepts the bargain price, the buyer is notified of the bargain price acceptance at step 10.7 and asks buyer for his acceptance. If the buyer accepts the offer, the payment process is initiated at step 10.8. If the buyer does not accept the accepted bargain price by Business Controller 2.0, then the buyer is asked to submit a new price range for bargaining or is offered an alternate solution as defined herein. In the event the bargain price is not accepted or the bargain price range is too low, then at step 10.9 Business Controller 2.0 informs the buyer of the non acceptance or informs the buyer that the bargain price range is too low, and requests the buyer to submit a new bargain price range or offers the buyer alternative products that are similar in specifications but have a different name brand etc. or offer other assistance as defined herein.

Online Bargaining with the Seller

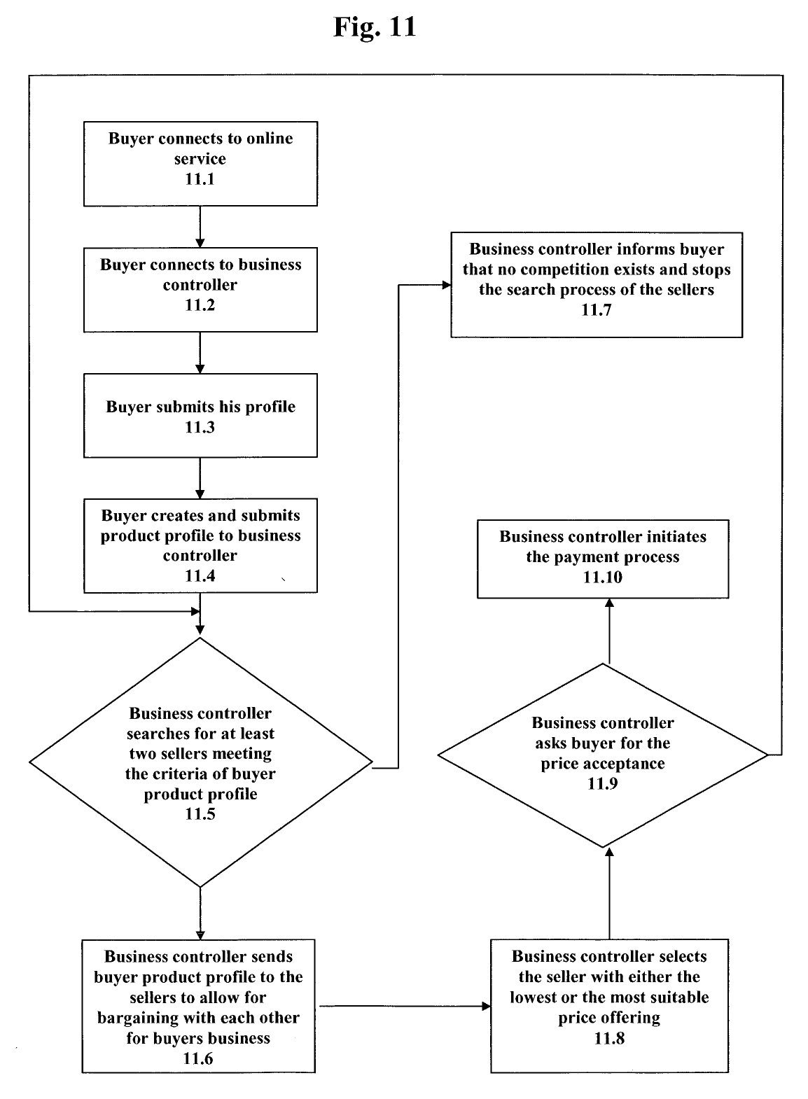

Referring to FIG. 11 there is illustrates an embodiment in which the buyer connects to bargaining terminals/station/booth located at the vendor location and submits product details at step 11.1. At step 11.2 buyer connects to Business Controller 2.0. At step 11.3 buyer creates his profile or if he is already a member uses his user ID and password and submits it to connect to Business Controller 2.0 online. At step 11.4 the buyer creates and submits a product profile giving specific details about the product, for example, category, type, make, model, color, and the like. At step 11.5, Business Controller 2.0 searches in seller database 1.4 to match at least two sellers meeting the buyer's product profile. If the product profile submitted by the buyer matches the sellers product offerings, then at step 11.6, Business Controller 2.0 sends the buyers profile to the sellers meeting the product offering criteria, and allows the seller to bargain either with each other or with the Business Controller 2.0 to arrive at the lowest or a most suitable final bargain price for the buyer. If Business Controller 2.0 cannot match at least two sellers with the buyer product profile, then at step 11.7 Business Controller 2.0 notifies the buyer of the result and stops the search. At step 11.8, Business Controller 2.0 selects the lowest or the most suitable final bargain price, and add a predetermined percentage typically at least about 1%, preferably about 5% to 20%, and more preferably about 5% to 15% based on the final bargain or sale price of the product or service, and updates response database 3.4. At step 11.9, Business Controller 2.0 sends the sellers final bargain price to the buyer, and asks for acceptance. If at step 11.10 buyer accepts the final bargain price offered by the seller, then Business Controller 2.0 initiates the payment process, arranges for the shipment of the product, and pays the seller as per the agreed upon terms and conditions. In the event buyer does not accept the final bargain price, then Business Controller 2.0 asks the buyer to broaden his/her request by changing the search range, product specifications or offers alternate products or continues to search for other sellers or continues the bargain process with the seller as per the iterations described herein.

The system also checks which of the vendors are on-line by checking the seller's database. It should be transparent to the buyer if the seller is on-line or off-line. The bargain module will offer bargain prices on behalf of the vendor who decides to bargain in proxy mode

BargainGuru “BAGU” Functionality Overview

The bargainGuru or “BAGU” will be computer memory resident program which will be downloadable from the Internet and reside on the users PC or handheld device or could be installed on the PC or handheld wireless device using removable media. The BAGU will get activated as soon the user switches on the PC or a handheld or a wireless device and load itself in the memory. BAGU would be configurable to suit the individual needs of the users and this configuration will be achieved by allowing user to setup the required functionality parameters supplied with the product. Moreover BAGU Software will be also available as ROM chip when this technology becomes available.

Following are the features and functionality of BAGU and each feature and functionality is explained in the sub sections below. BAGU could be disabled at the user command at any point and then activated again at user free will. Please note that in this instance BAGU will be still monitoring and capturing information in the background for future reference by writing it on the appropriate data capture media of the user PC or hand held or wireless device.

Interaction/Feedback Features

BAGU can be configured to perform the following functions “BAGU AT YOUR SERVICE” or “YOUR WISH IS MY COMMAND” and these can be configured in the functionality parameters. BAGU will interact with either the local database/programs or third party service providers for providing the user with requested information based on the user defined profile.

Bargaining

The base functionality of BAGU “BARGAINGURU” will include but not limited to translating/converting buyer currency into sellers native currency and vice versa by referring to the country code of the both parties and using the currency conversion tables/latest exchange rates available on the system. During the bargaining session BAGU will inform the seller(s) that the buyer is on-line by checking the status of the product being bargained for, to see if that is being bargained on-line or off-line. If the product is listed in the database as on-line then BAGU will check to see if the vendor or the seller is signed on and send an instant message notifying the seller that the buyer is on-line. If seller(s) does not respond back within a certain time span then either BAGU will inform the buyer that (s)he should try later, or act as a seller in case the seller has configured the product to be sold on his behalf, if he did not respond to the buyer request within the specified time defined in the sellers/product database. Furthermore the buyer can request BAGU to keep track of seller coming on-line and informing the buyer by sending an instant message or acting on behalf of the buyer in the bargaining process. If the buyer chooses to bargain off-line by defining the bargaining threshold then BAGU will bargain with the seller on his behalf.

The BAGU will provide buyer and the seller historical analysis and comparative quotes on the product and or services being bargained for by interacting with the database, where each and every request/transaction will be stored.

BAGU will bargain for specialized products and or service with the seller(s) for a limited time or as long it takes the seller(s) to accept the buyer(s) offered price and vice versa. Furthermore BAGU will provide feedback to the buyer and or seller(s) on the status of negotiation based on the feedback criteria selected, i.e. by minute, hourly, daily, weekly or on a monthly basis.

BAGU Desktop Install

The BargainGuru or “BAGU” is a computer memory resident program that can be downloaded from the Internet and resides on the users PC or handheld device, or could be installed on a PC or handheld wireless device using removable media. The BAGU will get activated as soon the user switches on the PC or a handheld or a wireless device, and loads itself in the device's memory. BAGU would be configurable to suit the individual needs of the users, and this configuration will be achieved by allowing user to setup the required functionality parameters supplied with the product. Moreover BAGU Software will be also available as ROM chip when this technology becomes available.

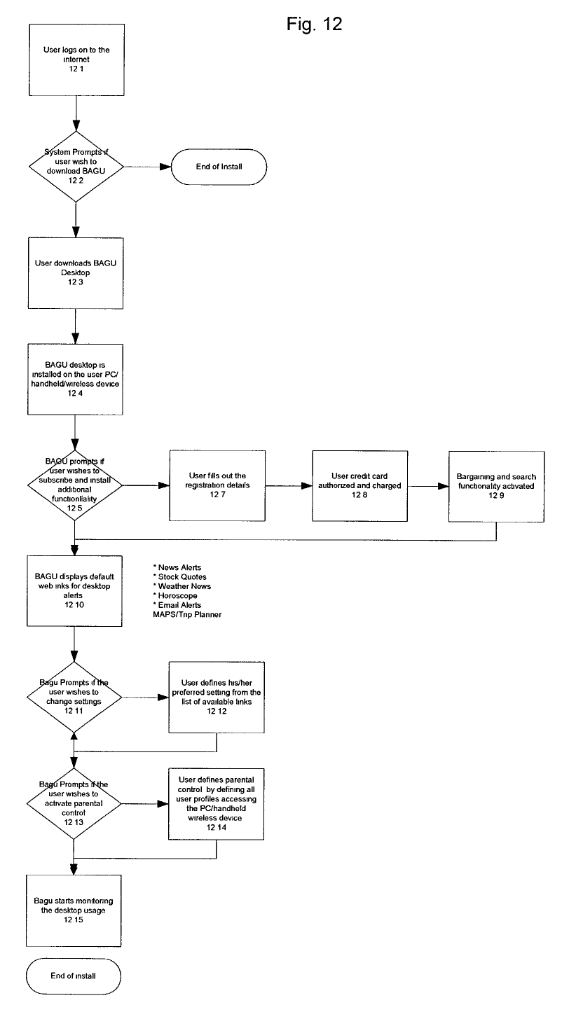

Additionally, with reference to FIG. 12, there is described the process by which user first downloads BAGU from the Internet and then configures and activates its functionality. At step 12.1 buyer connects to the Internet. At step 12.2 the user is prompted if (s)he wishes to download BAGU. If the user decides not to download BAGU the system will not prompt the user for downloading BAGU until he logs on to the Internet the next time. If the user decides to download BAGU desktop at step 12.3, BAGU desktop is downloaded and installed on user PC/handheld/wireless device at step 12.4. Once the desktop is installed it is activated and at step 12.5 the user is prompted if (s)he would like to activate advanced bargaining and search functionality which could be used when searching and bargaining for product and services at PriceBargains/PriceBargains Licensee web site. If the user decides to activate the advanced functionality (s)he fills out the registration details at step 12.6. User is prompted to enter credit card details at step 12.7 for authorizing and processing subscription amount. At step 12.8 advanced functionality is activated on the users BAGU desktop. At step 12.9 BAGU displays the default settings for Bargain Alerts, New Alerts, Stock Quotes, weather news, horoscope, email alerts and MAPS and trip planner and at step 12.10 prompts the user if (s)he wishes to change any settings. If the user wishes to change the settings s(he) can do that at step 12.11. Alternatively the user is prompted to activate parental control at step 12.12. At step 12.14 the user defines profile of all user accessing the PC/handheld/wireless device and which web sites they are not allowed access. Once the entire configuration is defined, BAGU desktop starts monitoring the device usage.

BAGU Desktop Functionality

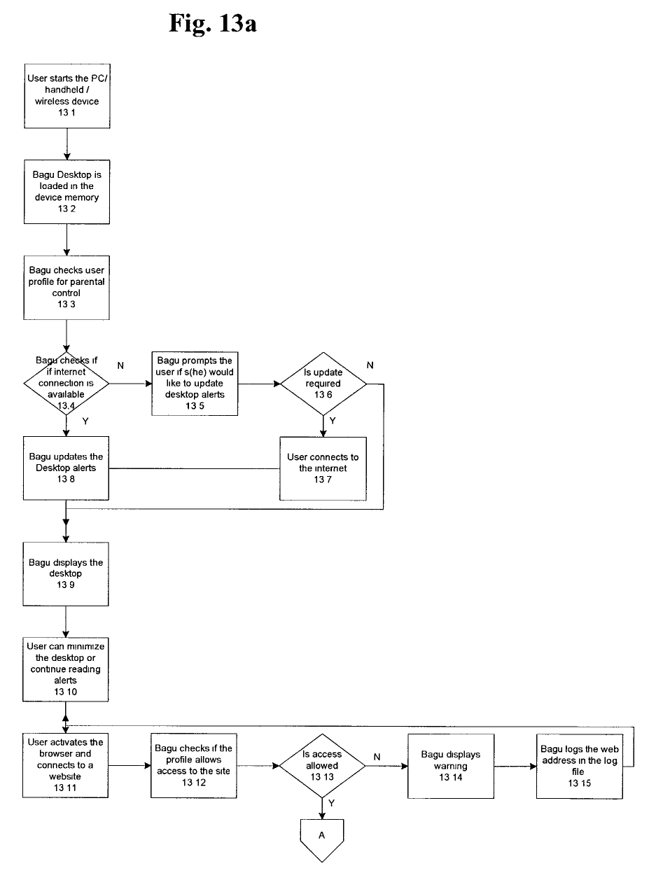

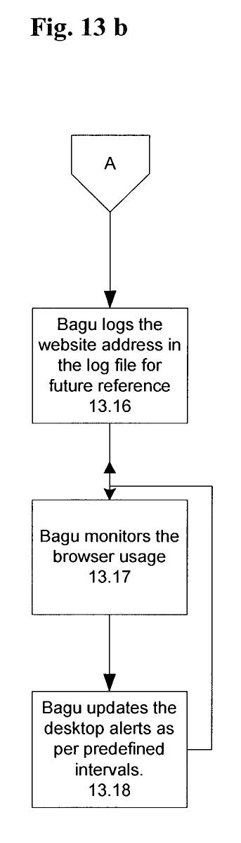

Usage of BAGU functionality is shown in FIGS. 13a and 13b. At step 13.1 the user starts PC/handheld/wireless device and at step 13.2 BAGU desktop is loaded into the device memory. Once activated at step 13.3 BAGU checks the user profile of the person signing on the device for parental control. In order to update the desktop alerts at step 13.4 BAGU checks if the device is connected to an Internet service provider (ISP). If the device is not connected to an ISP at step 13.5 BAGU prompts the user that Internet connection is not available for updating the Desktop Alerts. At step 13.6 BAGU prompts the user if (s)he wishes to update the Desktop Alerts. If the user wishes to update the Desktop Alerts (s)he connects to an ISP at step 13.7 and BAGU updates the Desktop Alerts at step 13.8. At step 13.9 BAGU desktop is displayed and at step 13.10 user can either read the alerts or minimize the desktop.

If the user wishes to connect to an Internet web site, at step 13.11 (s)he activates the web browser and connects to the desired web site. At step 13.12 and 13.13 BAGU checks if the user has authorization to connect to such web site. If at step 13.13 access is not allowed, BAGU displays a warning at step 13.14 and logs the web site address in the security log file on the user device at step 13.15.

If the user profile allowed access to the said web site BAGU logs the web site address in the preferences/knowledge log file of the user device for future reference. At step 13.17 BAGU monitors the browser usage and keeps on logging any new web site address in the preferences/knowledge log file of the user device, and at step 13.18 BAGU updates the desktop as per predefined time intervals.

BAGU Bargain Functionality

The base functionality of BAGU “BARGAINGURU” will include but not limited to translating/converting buyer currency into sellers native currency and vice versa by referring to the country code of the both parties and using the currency conversion tables/latest exchange rates available on the system. During the bargaining session BAGU inform the seller(s) that the buyer is on-line by checking the status of the product being bargained for, to see if that is being bargained on-line or off-line. If the product is listed in the database as on-line then BAGU will check to see if the vendor is signed on and send an instant message. If seller(s) does not respond back within a certain time span then either BAGU will inform the buyer that (s)he should try later or act as a seller in case the seller has configured the product to be sold on his behalf if he did not respond to the buyer request within the specified time defined in the sellers/product database. Furthermore the buyer can request BAGU to keep track of seller coming on-line and informing the buyer by sending an instant message or acting on behalf of the buyer in the bargaining process. If the buyer chooses to bargain off-line by defining the bargaining threshold and BAGU will bargain with the seller on his behalf.

BAGU will have the functionality to provide buyer and the seller historical analysis on the product or any product and or services being bargained for by interacting with the database, where each an every request/transaction will be stored.

BAGU will bargain for specialized products and or service with the seller(s) for a limited time or as long it takes the seller(s) to accept the buyer(s) offered price and vice versa. Furthermore BAGU will provide feedback to the buyer and or seller(s) on the status of negotiation based on the feedback criteria selected i.e. by minute, hourly, daily, weekly or on a monthly basis.

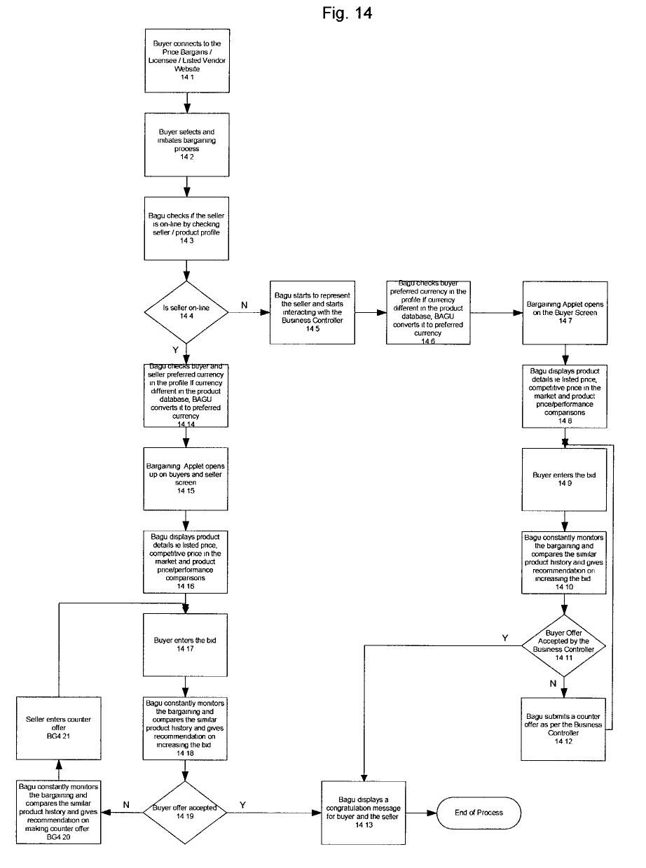

Additionally, with reference to FIG. 14, there is described the process by which BAGU will facilitate the bargaining process.

At step 14.1 Buyer connects to the PriceBargains/Licensee/Listed Vendor web site. Buyer searches for product or service, and after making a selection initiates bargaining process at step 14.2. BAGU, installed on the buyer desktop, connects to the Business Controller/seller and product profile to check if the seller is online at step 14.3. If the seller is online, BAGU proceeds to step 14.14. Otherwise, BAGU proceeds to step 14.5. If the seller is online BAGU, at step 14.14, checks buyers and seller preferred bargaining currency. If the preferred bargaining currency is different then the selected product/service currency, BAGU converts it to preferred currency. At step 14.15 the bargaining applet opens on the buyers and sellers device. At step 14.16 BAGU displays product details i.e. listed price (Converted), competitive price in the market and price and performance comparison. At step 14.17 buyer enters his bid. At step 14.18 BAGU constantly monitors the bargaining and compares the buyer offer with the transaction history of a similar product/service and makes recommendations on increasing the offer and how close the buyer is in getting the product/service. At step 14.19 BAGU checks to determine whether the buyer has been accepted by the seller. If buyer is accepted, BAGU proceeds to process the payment to step 14.13. Otherwise, BAGU proceeds to step 14.20. At step 14.20 BAGU makes a similar recommendation to the seller for making a counter offer. At step 14.21 the seller enters a counter offer and this process continues until seller accepts the offer or buyer decides to terminate bargaining. If the buyer's offer is accepted by the seller BAGU at step 14.13 displays a message congratulating the buyer and the seller, and control is transferred for payment, and processed as described hereinabove.

If the seller is not online at step 14.5 BAGU starts representing the seller without buyer knowing that the seller is not online. At step 14.6 BAGU checks buyers preferred bargaining currency and if it differs from the selected product/service currency, BAGU converts it to preferred currency as well as display the equivalent amount in US dollars. At step 14.7 the bargaining applet opens on the buyers device and at step 14.8 BAGU displays product details i.e. listed price (Converted), competitive price in the market and price and performance comparison. At step 14.9 buyer enter his bid. At step 14.10 BAGU constantly monitors the bargaining and compares the buyer offer with the transaction history of a similar product/service and make recommendations on increasing the offer and how close the buyer is in getting the product/service. At step 14.11 BAGU checks if the buyer offer has been accepted by the Business Controller. If the buyer offer is accepted, BAGU proceeds to step 14.13 else proceeds to step 14.12, where BAGU submits a counter offer as per the Business Controller and this process continues until buyer offer is accepted by the Business Controller or buyer decides to terminate bargaining. If Business Controller accepts the buyers offer, BAGU at step 14.13 displays a message congratulating the buyer and the seller and control is transferred to the payment process.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A computer-based intelligent Internet bargaining system, comprising:
a. an intelligent business controller having an electronic assistant BargainGuru, BAGU which takes into account the selling preferences of the vendors and buying preferences of the buyers to negotiate a sale price;
b. a network interface;
c. a memory, data storage device;
d. an operating system;
e. a database management system;
f. a database; and
g. said system having a high bandwidth connection to the Internet.

2. A system as recited by claim 1, being configured to act as a web-server communicating with buyers and sellers using a communication mode selected from the group consisting of on-line, off-line and real-time.

3. A system as recited by claim 1, being further configured to process requests from buyers and/or sellers to negotiate a final selling price using an intelligent electronic bargaining assistant.

4. A system as recited by claim 1, being further configured to accept seller pricing preferences and buyer preferences to store and access data related to buyers and sellers, to guide buyers and sellers in the negotiation process.

5. A system as recited by claim 1 wherein the bargaining assistant is able to negotiate with the buyer to conclude a sale on behalf of the seller, said seller being offline, and said bargaining assistant using seller's pricing strategies and preferences.

6. A system as recited in claim 1 wherein the bargaining assistant is able to negotiate with the seller to arrive at a sale price on behalf of the buyer, said buyer being offline, and said bargaining assistant using buyer preferences,

7. A system as recited by claim 1, being further configured to interact with multiple customers while, at the same time providing each customer with his/her own bargain.

8. A system as recited by claim 5, being further configured to enable buyers and sellers to input data related to a bargaining process.

9. A system as recited by claim 1, being further configured to be implemented on a distributed network wherein multiple business controller modules are connected to multiple customers.

10. A system as recited by claim 7, wherein said distributed network comprises the Internet and said interface comprises a Web browser.

11. A system as recited by claim 1 wherein the business control module is connected only to a local server and negotiates a sale and keeps track of inventory of the store,

12. A system as recited by 9, wherein said system further comprises a program for:
a. enabling buyers to register by agreeing to the terms and conditions of the BargainGuru system;
b. enabling buyers to submit a buyer profile containing preselected information about said buyers; and
c. enabling buyers to login to the system and bargain for goods and/or services.

13. A system as recited by claim 12, wherein said system program is further configured to issue a unique membership identification and password to said buyers and to sellers registering with the system.

14. A system as recited by claim 1, further configured to register users by:
a. asking for their profile and preselected information about said users;
b. storing said profile and said preselected information in a secure database; and
c. issuing to buyer and seller a unique membership identification number.

15. A system as recited by claim 12, wherein said system program is configured to authenticate the buyer and/or seller to use the service provided by the system program.

16. A system as recited by claim 1, wherein said system program is configured to provide buyer with preselected product information, including a list comprising products available for purchase through said system, product prices, and relative information concerning products using the BargainGuru electronic assistant system.

17. A system for bargaining over the Internet, comprising:
a. a processor;
b. a network interface;
c. a memory;
d. a data storage device;
e. an operating system;
f. a database management system
g. a database; and
h. and a high bandwidth connection to the Internet;
i. said system being configured to act on behalf of a customer comprised of a buyer or a seller, and to perform a bargaining process comprising the steps of:
j. generating a bargain offer proposed by said customer;
k. accepting or rejecting a counter offer proposed by said system for said customer;
l. providing choices available to said customer and assisting said customer with product selection and bidding opportunities to arrive at a best bargain price;
m. guiding said customer throughout said bargaining process using bargaining assistant recommendations including comparative quotes, product ratings, alternative products, and pricing assistance.

18. A system as recited by claim 17, further configured to obtain a deal best suited to the buyer through the system by providing said comparative quotes for a particular product appointed for purchase from the system, said comparative quotes being obtained by searching for information or prices published by other extant systems or websites that sell substantially the same product.

19. A computer-based interactive program, comprising:
a. a business control module with intelligent electronic assistant BargainGuru
b. a payment processor module;
c. a bargain formulation processor module;
d. a database management module;
e. a network interface module;
f. each of said payment processor, bargain formulation, database management and network interface modules running on an operating system, in coordination with a system, as recited by claim 1; and
g. said program being further configured for attachment thereto of at least one additional module.

20. A computer program as recited by claim 19, configured to run on a web-server communicating with buyers and sellers using a communication mode selected from the group consisting of on-line, off-line and real-time.

21. A computer program as recited by claim 19, being further configured to process requests from buyers and sellers.

22. A computer program as recited by claim 19, being further configured to store data related to buyers and sellers, transactions, responses, bargain prices, and bargain deals for use in connection with database operations.

23. A computer program as recited by claim 19, being further configured to have an interface that provides means enabling buyers and sellers to access the products and/or services available through the system for sale.

24. A computer program as recited by claim 23, being further configured to enable buyers and sellers to input data related to a bargaining process.

25. A computer program as recited by claim 19, being further configured to be implemented on a distributed network.

26. A computer program as recited by claim 25, wherein said distributed network comprises the Internet and said interface comprises a Web browser.

27. A computer program as recited by claim 25, wherein said computer program further comprises a program for enabling buyers to (a) register by agreeing to the terms and conditions of the system (b) submit a buyer profile containing preselected information about said buyers, and (c) login to the system and bargain for goods and/or services.

28. A computer program as recited by claim 27, wherein said computer program is further configured to issue a unique membership identification and password to said buyers and to sellers registering with the system.

29. A computer program as recited by claim 19, further configured to register users by (a) asking for their profile and preselected information about said users; (b) storing said profile and preselected information in a secure database; and (c) issuing to buyer and seller a unique membership identification number.

30. A computer program as recited by claim 27, wherein said computer program is configured to authenticate buyer and/or seller to use services provided by the computer program.

31. A computer program as recited by claim 19, wherein said system is configured to provide buyer with preselected product information, including a list comprising products available for purchase through said system, product process and relative information concerning products, said preselected product information being provided after buyer logs onto the system by inputting buyer's membership ID and password.

32. A computer program as recited by claim 19, wherein said computer program is further configured to receive from a remote buyer a purchase comprising:
a. a purchase offer; and
b. a payment identifier specifying a financial account from which funds are appointed to be paid for a purchase of a product or service under conditions meeting buyer's requirements.

33. A computer program as recited by claim 19, wherein said computer program is further configured to initiate use of a financial account to effect said payment from said buyer.

34. A computer program as recited by claim 19, wherein said computer program is further configured to receive payment from said buyer through an electronic settlement system and said settlement system comprises electronic fund transfer, digital cash, electronic cash and a credit card system selected from the group consisting of credit card and debit card.

35. A computer program as recited by claim 27, wherein said purchase offer from said buyer comprises information elements, including product quantity, product quality, purchase date, purchase price, payment terms, date of delivery, pickup location and delivery location of said product or services and issuing coupon identifying the purchase.

36. A computer program as recited by claim 35, wherein said system computer program is further configured to notify buyer that buyer's purchaser offer is accepted and buyer has entered into a legally binding contract with the system.

37. A computer program as recited by claim 35, wherein said computer program is further configured to generate a bargain price response to buyer's purchase offer and transmit said bargain price response to said buyer.

38. In a computer program for electronically making a binding contract between buyer and seller, the improvement comprising the steps of;
a. receiving a purchase offer from the buyer containing a buyer request and a buyer payment identifier specifying a financial account from which funds may be paid for a purchase meeting criteria set by the buyer; and
b. notifying said buyer concerning acceptance or rejection of said purchase offer.
